(19) United States
(12) Patent Application Publication
(10) Pub. No.: US 2007/0276813 A1
(43) Pub. Date: Nov. 29, 2007

(54) Online Advertisement Selection and Delivery Based on Search Listing Collections

(76) Inventor: Joshua Rosen, Bolinas, CA (US)

Correspondence Address: PATTERSON & SHERIDAN, L.L.P., 3040 POST OAK BOULEVARD, SUITE 1500, HOUSTON, TX, 77056, US

(21) Appl. No.: 11/752,287

(22) Filed: May 22, 2007

Related U.S. Application Data
(60) Provisional application No. 60/803,022, filed on May 23, 2006.

(51) Int. Cl. G06F 17/30

(52) U.S. Cl. 707/3

(57) ABSTRACT

A search engine generates search results and at least one advertisement to be displayed adjacent to the search results, wherein the search results and the at least one advertisement are to be displayed in independently updateable sections. The search results include one or more search listing collections, and the advertisement that is to be displayed adjacent to a search listing collection is selected based on its relevance to the particular search listing of the search listing collection that is to be displayed therewith. The advertisements may be a collection of advertisements that are displayed one at a time in an independently updateable section.

### CROSS-REFERENCE TO RELATED APPLICATIONS

This application claims the benefit of U.S. Provisional Patent Application Ser. No. 60/803,022, filed May 23, 2006, the entire contents of which are incorporated by reference herein.

### BACKGROUND OF THE INVENTION

1. Field of the Invention

The present invention relates generally to search engines and, more particularly, to search engines that select and deliver online advertisement based on search listing collections.

2. Description of the Related Art

Search engines have become popular tools to identify and locate specific information on the Internet. A search engine is a computer program that, when queried for information, retrieves either related information or pointers to the location of related information, or both, by evaluating content stored in its search database.

The search engines provided by Internet search services, such as Yahoo!, Google and MSN, accept a search query and returns search results ranked in accordance with their respective relevance algorithm. These search results are displayed through a graphical user interface (GUI) that includes an editable text field that displays the search query, a listing of search results, and a listing of text advertisements known in the art as sponsored links. A click on any of the search results hyperlinks the user to the web site associated with that search result and a click on any of the sponsored links hyperlinks the user to the web site of the sponsor.

Sponsored links are associated with one or more keywords and are generated in response to a search query that contains matching keywords. For each click on a sponsored link, the sponsor agrees to pay the search engine service provider a pay-per-click amount specified by the sponsor. The ranking of sponsored links is determined in accordance with the pay-per-click amounts. Generally, paying higher pay-per-click amounts increases the ranking of the sponsored links. This process is described in further detail in U.S. Pat. No. 6,269,361, the entire contents of which are incorporated by reference herein.

### SUMMARY OF THE INVENTION

The present invention provides a novel technique for incorporating sponsored links within search results generated by a search engine. According to an embodiment of the present invention, a search engine generates search results and at least one advertisement to be displayed adjacent to the search results, wherein the search results and the at least one advertisement are to be displayed in independently updateable sections. According to another embodiment of the present invention, a search engine generates one or more search listing collections as search results and at least one advertisement to be displayed with the one or more search listing collections.

A GUI according to an embodiment of the present invention, includes a first section including a text input field for a search query, and a second section comprising at least a first subsection for displaying at least one search result that is responsive to the search query and a second subsection proximate said first subsection for displaying at least one advertisement that is relevant to said at least one search result and the search query, wherein the displayed content of each one of the subsections can be updated independently with respect to the first section and other subsections, in response to data received from the server computing device. The search result displayed in the first subsection may be one of the search listings in a search listing collection, and the second subsection that displays the advertisement may be updated each time a different search listing from the search listing collection is displayed in the first subsection.

The method for generating a response to a search query, according to an embodiment of the present invention, includes the steps of receiving a search query, storing search results that are responsive to the search query, wherein the search results include at least one search listing collection having multiple search listings that are displayed one at a time, storing an advertisement that is responsive to the search query and relevant to the search listing collection, and transmitting the stored search results and the advertisement as the response. The advertisement that is selected to be transmitted is the one that is the most relevant to the search listing in the search listing collection that is to be initially displayed.

The method for generating a response to a search query, according to another embodiment of the present invention, includes the steps of transmitting a search query to a server computer, receiving search results that are responsive to the search query, wherein the search results include at least one search listing collection having multiple search listings that are displayed one at a time, receiving an advertisement that is responsive to the search query, and displaying the stored search results and the advertisement. The advertisement that is received is the one that is the most relevant to the search listing in the search listing collection that is to be initially displayed. The advertisement that is displayed may be changed each time a different search listing from the search listing collection is displayed.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A illustrates a networked computer environment in which the present invention may be practiced.

FIG. 1B is a block diagram of an exemplary client computer that is part of the networked computer environment shown in FIG. 1A.

FIGS. 2A-2C are schematic representations of a GUI according to an embodiment of the present invention that displays search listings in combination with sponsored links.

FIG. 3 illustrates one process for generating the GUI shown schematically in FIG. 2A.

FIG. 4A is a flow diagram that illustrates the steps carried out by a server computer to generate search results and sponsored links according to an embodiment of the present invention.

FIG. 4B is a flow diagram that illustrates the steps carried out by a server computer to update the search results display that includes sponsored links according to an embodiment of the present invention.

FIG. 5A is a flow diagram that illustrates the steps carried out by a client computer to deliver a search result GUI according to an embodiment of the present invention.

FIG. 5B is a flow diagram that illustrates the steps carried out by a client computer to update a search result GUI according to an embodiment of the present invention.

FIG. 7 is a schematic representation of a web page that includes a GUI according to still another embodiment of the present invention.

FIG. 8 is a flow diagram that illustrates the steps carried out by a client computer in response to a user who is making inputs to a GUI that displays a search listing collection.

FIG. 9 is a flow diagram that illustrates the steps carried out by a web server computer to generate a web page including a sponsored link collection for display at a client computer.

### DETAILED DESCRIPTION

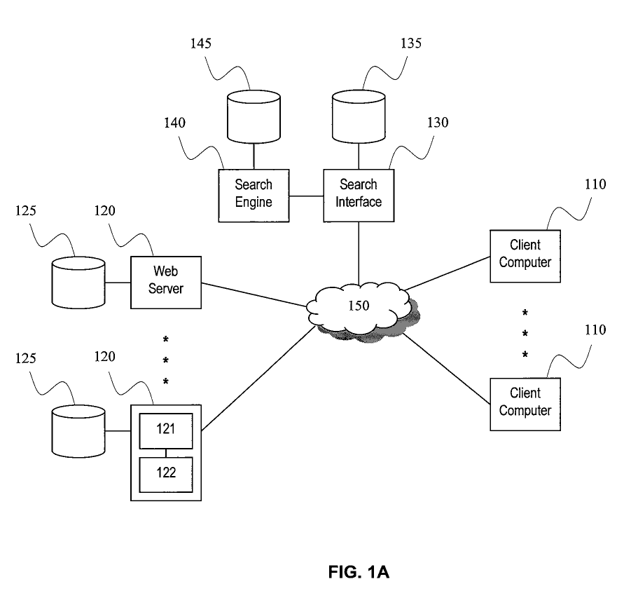

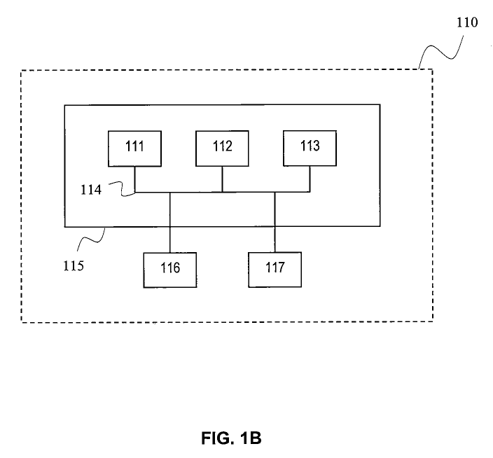

FIG. 1A illustrates a networked computer environment in which the present invention may be practiced. As shown, the networked computer environment includes a plurality of client computers 110 (only two of which are shown), a plurality of web servers 120 with associated content storage units 125 (only two of which are shown), a search interface web server 130 with an associated content storage unit 135, and a search engine web server 140 with an associated content storage unit 145. The client computers 110, the web server computers 120, the search interface web server 130, and the search engine web server 140 are connected over a computer network 150, e.g., the Internet.

The search engine web server 140 may be operated by the same party that is operating the search interface web server 130. In some implementations, the functions of the search interface web server 130 and the search engine web server 140 can be carried out by a single web server. The search engine web server 140 may also be operated by a different party, e.g., an Internet search services provider. As another alternative, the search engine functions may be provided by both the party that is operating the search interface web server 130 and an Internet search services provider.

As illustrated in FIG. 1B, each client computer 110 includes conventional components of a computing device. They include a processor 111, system memory 112 and a hard disk drive 113, that communicate over a bus 114 and are contained within a housing 115, and external devices such as input devices 116, e.g., a mouse and a keyboard, and output devices 117, e.g., a monitor and a printer. Each web server (which may be any of the web servers 120, the search interface web server 130, and the search engine web server 140) includes a processor 121 and a system memory 122, and manages the contents stored in its respective content storage unit using software, e.g., a relational database software. The web server is programmed to communicate with the client computers 110 and other web servers using the TCP/IP protocol. The client computers 110 are programmed to execute web browser programs and access the web pages managed by the web servers by specifying a uniform resource locator (URL) for the web server into the browser.

In the embodiments of the present invention described below, users are respectively operating the client computers 110 that are connected to the search interface web server 130 over the Internet. The web pages that are displayed to a user are transmitted from the search interface web server 130 to that user's client computer 110 and processed by the web browser program stored in that user's client computer 110 for display through the monitor of that user's client computer 110.

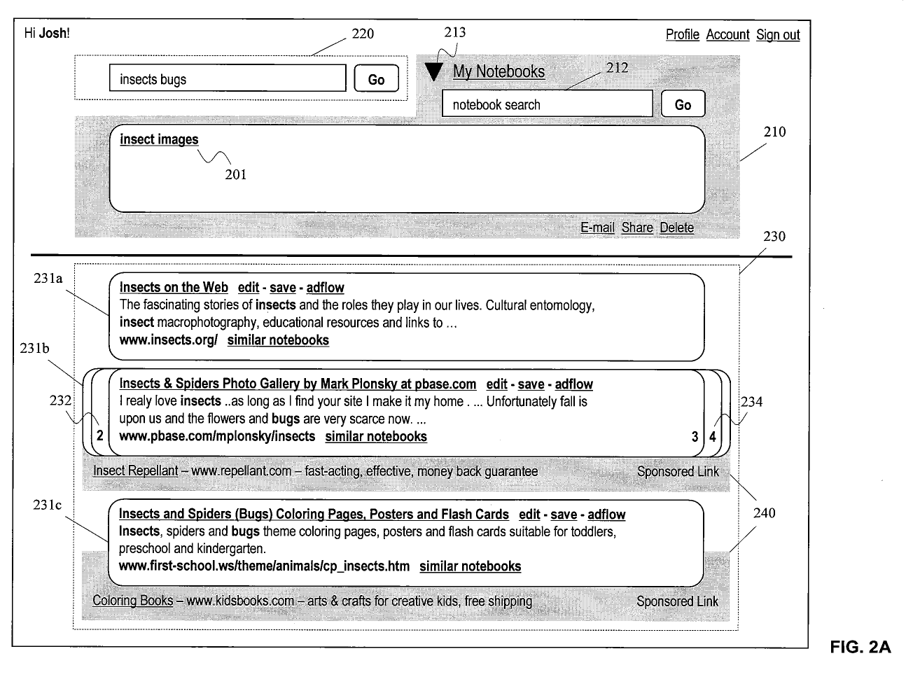

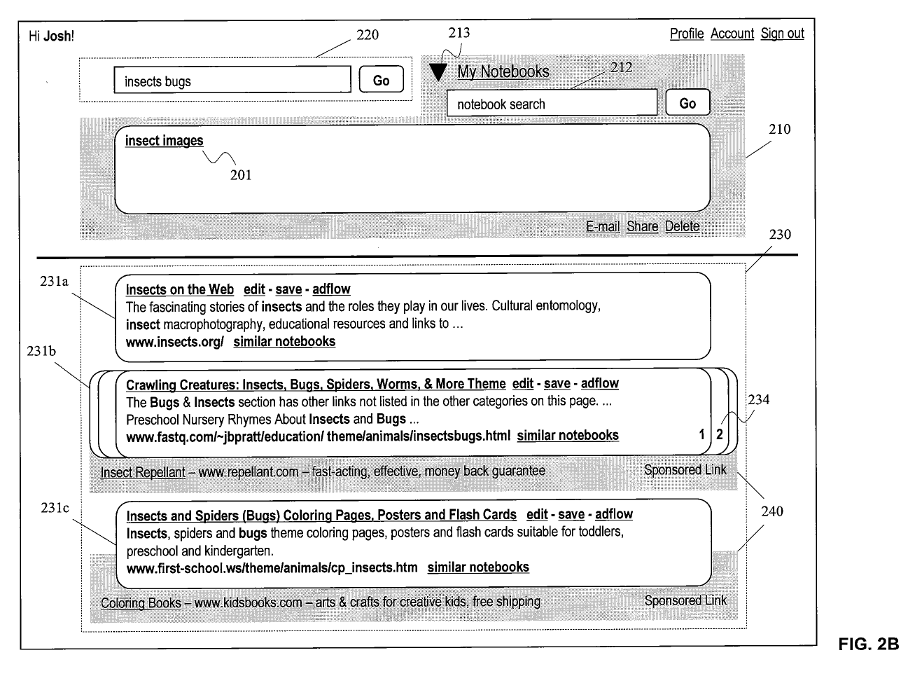

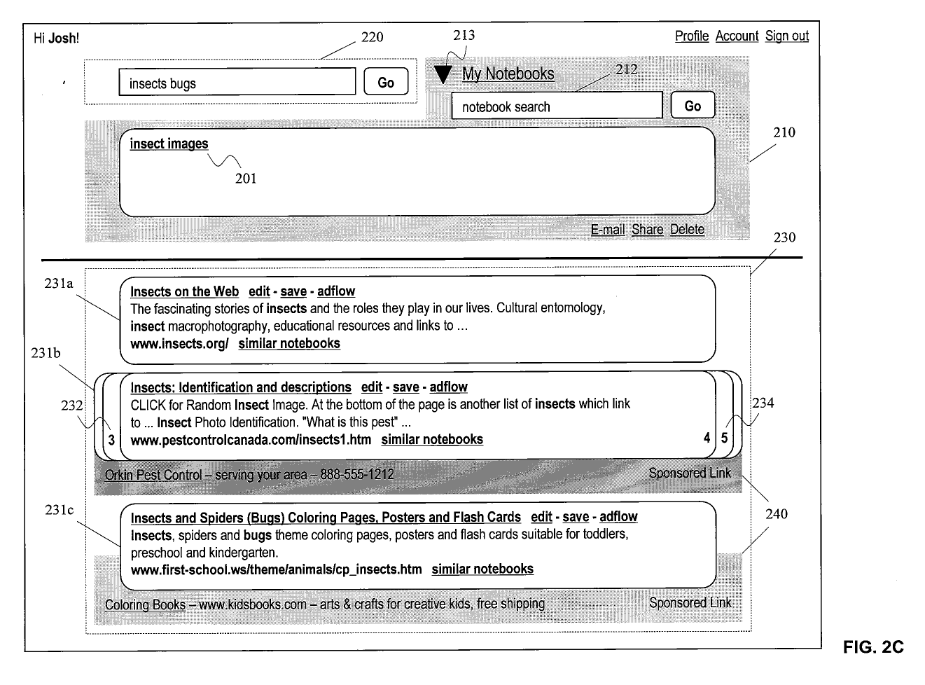

FIGS. 2A-2C are schematic representations of a GUI according to an embodiment of the present invention. This GUI is generated by the client computer 110 based on content transmitted by the search interface web server 130. The GUI schematically represented in FIGS. 2A-2C has three different sections including a first section 210, a second section 220, and a third section 230. The first section 210 is a section for collecting search results into user-defined groups, referred to herein as “search listing collections” or “notebooks” and managing the notebooks. A list 201 of three such notebooks is shown in FIGS. 2A-2C inside the first section 210. A notebook may be shared with another user using the E-mail hyperlink or by specifying viewing and editing privileges for the other users using the Share hyperlink. A user who has viewing privileges to a notebook may import the notebook into his or her personal collection of notebooks. The first section 210 can be collapsed (or expanded after it has been collapsed) by clicking on the arrow 213. The drop region of the first section 210, identified with a darker background in FIG. 2, is active in either the expanded state or the collapsed state, so that search results can be added to a notebook by selecting them, dragging them to this region and then dropping them in this region. The second section 220 is a section for inputting a search query. The third section 230 is a section for displaying search results 231 that are responsive to the search query, and sponsored links (e.g., text advertisements 240) that are responsive to the search query. In the embodiment of the GUI shown in FIGS. 2A-2C, a sponsored link appears directly underneath a search result, such as under search result 231b or 231c.

Each search result 231 provides an abstract of, and a hyperlink to, the web site with which it is associated, and several additional hyperlinks, including “edit,” “save,” and “similar notebooks.” The “edit” hyperlink allows the owner of the web site to edit the abstract of his or her web site. The edited abstract is stored by the search interface web server 130, so that the next time such web site is included in a search result, the edited abstract is displayed to the user. The “save” hyperlink allows the user to save a search result into a notebook. If the user clicks on the “save” hyperlink from the displayed page of a notebook (such as search result 231b), the user is prompted to choose between “save the entire notebook” and “save this page from the notebook.” If the user clicks on the “save” hyperlink from an individual search listing, the individual search listing is stored in the notebook that is currently open in the first section 210. If no notebook is currently open in the first section 210, the user is prompted for a name of a new notebook or an existing notebook into which the individual search listing will be added. The “adflow” hyperlink allows the owner of the web site to create a text advertisement of his or her web site that can be used as a text advertisement appearing in pay-per-click search services like Google Adwords or Overture. The “similar notebooks” hyperlink of a search result causes to be displayed a pop-up menu of notebooks that are most relevant to the search result, when a user clicks on or positions a cursor of a pointing device on top of this hyperlink. A selection of one of the notebooks causes that notebook to be displayed in the display section for the search result in place of the search result.

Each of the three sections 210, 220, 230 comprises at least one inline frame. The first section 210 comprises one inline frame. The second section 220 comprises one inline frame. The third section 230 comprises multiple inline frames. Each search result 231 in the third section 230 is displayed in a separate inline frame, and each sponsored link 240 in the third section 230 is displayed in a separate inline frame. Some search results, such as search result 231b, may comprise notebooks. For these, the pages from the notebooks are displayed one at a time. Other pages of the notebooks can be accessed by clicking on a GUI control for the previous page number (e.g., GUI control 232) or the next page number (e.g., GUI control 234). The page number of the current page is also displayed.

A GUI having inline frames permits any one of the inline frame to be updated with new content without disrupting the rest of the GUI. For example, when a user clicks on the GUI controls 232, 234 appearing in the inline frame corresponding to search result 231b, the display contents of this inline frame are updated without disrupting the rest of the GUI.

The GUI of FIG. 2A represents the initial search result display generated by client computer 110 in response to search result contents received from the search interface web server 130. In FIG. 2A, page 3 of the notebook 231b is displayed, because that page was determined by the search interface web server 130 to be the most relevant, relative to the other pages in the notebook 231b, to the search query specified in the section 220. The sponsored link included in the search result contents and displayed in section 240 underneath notebook 231b is the sponsored link that was determined by the search interface web server 130 to be the most relevant to page 3 of the notebook 231b.

FIG. 2B is a schematic representation of the GUI of FIG. 2A after a user navigates to page 1 of the notebook 231b by clicking on the GUI control 232 for turning notebook pages back two times. The displayed search listing is now page 1 of the notebook 231b. However, the associated sponsored link did not change, because it was determined by the search interface web server 130 that the displayed sponsored link is the most relevant to both pages 1 and 3 of the notebook 231b.

FIG. 2C is a schematic representation of the GUI of FIG. 2A after a user navigates to page 4 of the notebook 231b by clicking on the GUI control 234 for turning notebook pages forward one time. The displayed search listing is now page 4 of the notebook 231b. Here, the associated sponsored link did change, because it was determined by the search interface web server 130 that the sponsored link that is the most relevant to page 4 of the notebook 231b is different from that of page 3 of the notebook 231b.

In the embodiment of the present invention described above, the different sponsored link is retrieved from the search interface web server 130 each time it is needed. In alternative embodiments of the present invention, the different sponsored links for all pages of notebooks that are part of displayed search results may be pre-loaded into the client computer 110 for rapid display. Further, in the embodiments of the present invention described herein, the relevance of a sponsored link to a search listing is determined based on contextual similarity. Other methods for determining relevance (e.g., by pay-per-click bid amounts, click-through rates, etc.) may be used.

In FIG. 2C, the sponsored link that is displayed with the notebook 231b is shown with a darker background than in FIGS. 2A and 2B. This is done to represent the color, yellow, as a way to signify that the sponsored link is a listing from an online version of the Yellow Pages.

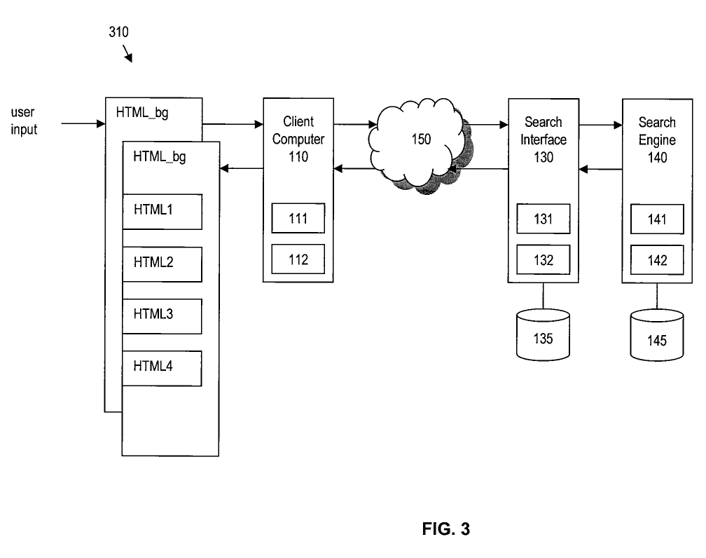

FIG. 3 illustrates one process for generating the GUI shown schematically in FIG. 2A. In the process illustrated in FIG. 3, the display contents for GUI 310, exclusive of the search results, are represented as HTML_bg, and the display contents of each of the search results provided in an inline frame are represented as HTMLn. The user input is represented as user_input. The components of the client computer 110 shown in FIG. 3 include a processor 111 and a memory unit 112. A web browser program is stored in the memory unit 112 and executed by the processor 111 to manage the interactions between it and the search interface web server 130 over the Internet 150. The components of the search interface web server 130 shown in FIG. 3 include a processor 131 and a memory unit 132. A web server program is stored in the memory unit 132 and executed by the processor 131 to manage the interactions between it and the client computer 110 over the Internet 150. The memory unit 132 also stores a program executable by the processor 131 for interacting with the search engine web server 140, e.g., transmitting a search request and receiving search results and sponsored links in response thereto. The components of the search engine web server 140 shown in FIG. 3 include a processor 141 and a memory unit 142. A search engine program is stored in the memory unit 142 and executed by the processor 141 to carry out searches requested by the search interface web server 130.

FIG. 3 illustrates a GUI 310 at two different points in time. Initially, the GUI 310 has no search results displayed. Then, the user submits a search request, represented as user_input, through the GUI 310. The client computer 110 passes on this search request to the search interface web server 130 over the Internet 150. The search interface web server 130 passes on this search request to the search engine web server 140 and receives search results and sponsored links in response thereto. The search results are initially ranked in accordance with the relevance algorithm used by the search engine web server 140, and the sponsored links are initially ranked in accordance with the ranking algorithm used by the search engine web server 140 (e.g., sponsored links with higher pay-per-click amounts get higher rankings). The search interface web server 130 then searches for notebooks that are to be included in the search results and, for each page of the notebooks to be included, the sponsored link that is the most relevant. Upon receiving this information, the client computer 110 generates the GUI 310 with new display contents for HTML_bg, and the search results displayed in separate inline frames, which are represented in FIG. 3 as HTML1, HTML2, HTML3, and HTML4.

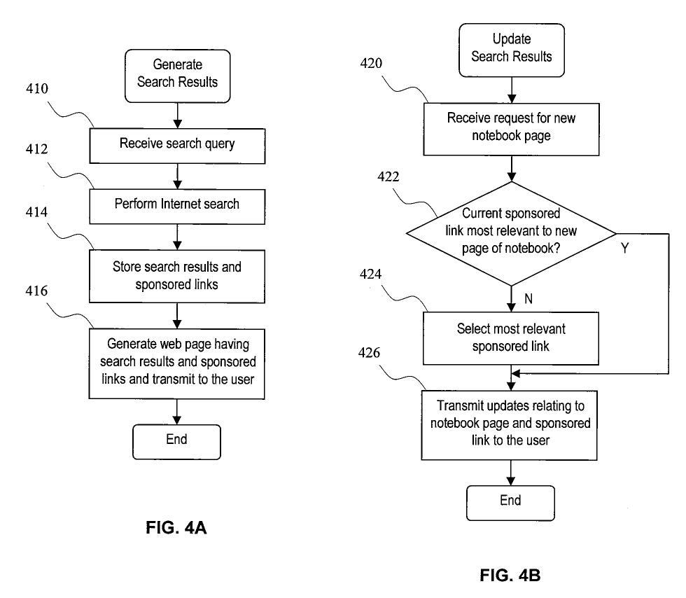

FIG. 4A is a flow diagram that illustrates the steps carried out by a server computer to generate search results and sponsored links according to an embodiment of the present invention. In step 410, the search interface web server 130 receives a search query from a client computer 110 over the Internet 150. Then, in step 412, the search interface web server 130 performs the requested search through the search engine web server 140. The search engine web server 140 generates the search results and the sponsored links in a particular order and transmits them to the search interface web server 130, which stores them and selects the sponsored links that are to be displayed with any of the search results (step 414). The search interface web server 130 then generates a web page with the search results and any sponsored links selected in step 414, and transmits the web page to the client computer 110 over the Internet 150 (step 416). The client computer 110 then generates a GUI that includes the search results and any sponsored links received from the search interface web server 130, such as the one shown schematically in FIG. 2A.

FIG. 4B is a flow diagram that illustrates the steps carried out by the search interface web server 130 to update the search results display that includes sponsored links according to an embodiment of the present invention. In the example given herein, a user operates one of the GUI controls 232, 234 (see FIG. 2A) to view another page of the notebook 231b. In step 420, the search interface web server 130 receives this request for a new notebook page from the user. A check is made in step 422 to see if the sponsored link that is currently displayed with the notebook 231 b is the most relevant to the new page being requested. If it is not, a new sponsored link that is the most relevant to the new page being requested is selected (step 424) and flow proceeds to step 426. If it is, step 424 is skipped and flow proceeds to step 426. In step 426, the updates to the notebook display and any updates to the sponsored link display are transmitted to the user.

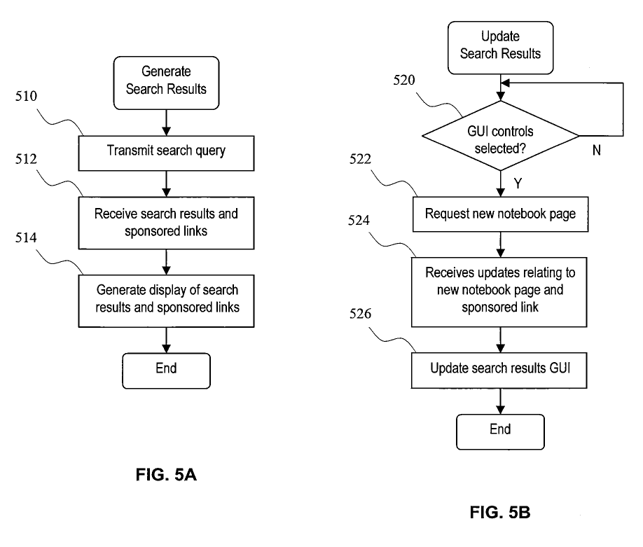

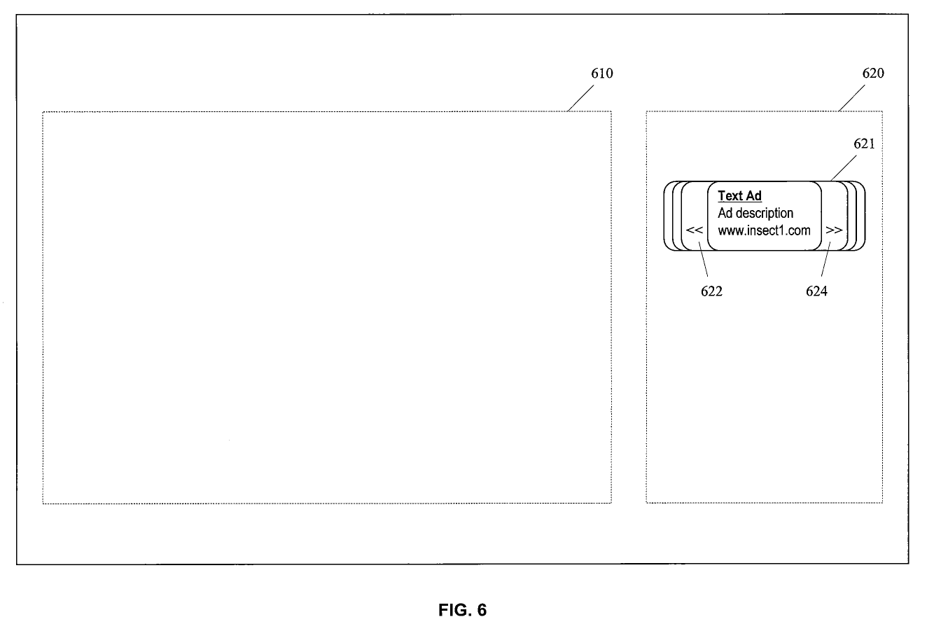

FIG. 5A is a flow diagram that illustrates the steps carried out by the client computer 110 to deliver a search result GUI according to an embodiment of the present invention. In step 510, a search query entered by the user is transmitted to the search interface web server 130 over the Internet 150. In response thereto, the client computer 110 receives search results that are responsive to the search query, wherein the search results include a search listing collection and a sponsored link that has been determined by the search interface web server 130 to be the most relevant to the search listing collection (step 512). In step 514, the client computer 110 displays the search results and the sponsored link as a GUI like the one shown in FIG. 2A.

FIG. 5B is a flow diagram that illustrates the steps carried out by a client computer to update a search result GUI according to an embodiment of the present invention. In the example given herein, a user makes inputs from a search results GUI like the one shown in FIG. 2A. In step 520, a check is made to see if the user has made a request for a new notebook page using one of the GUI controls 232, 234. If so, in step 522, the client computer 110 transmits this request to the search interface web server 130 over the Internet 150. A check is made by the search interface web server 130 to see if the sponsored link that is currently displayed with the notebook 231b is the most relevant to the new page being requested. If it is not, a new sponsored link that is the most relevant to the new page being requested is selected and transmitted to the client computer 110 along with the new notebook page. If it is, only the new notebook page is transmitted to the client computer. In step 524, the updates to the notebook display and the sponsored link display are received by the client computer 110. Then, in step 526, the client computer 110 updates the search results GUI in accordance with the received updates.

In the processes illustrated above, a new notebook page and a new sponsored link are retrieved from the search interface web server 130 each time they are needed. In alternative embodiments of the present invention, all of the different pages of the notebook and the associated most relevant sponsored links may be pre-loaded into the client computer 110 for rapid display.

FIG. 6 is a schematic representation of a web page that includes a GUI according to another embodiment of the present invention. This web page includes a content section 610, which includes content of any type including user profiles, news articles, search results, blogs, discussion threads, etc., and an advertisement section 620, which includes a collection 621 of sponsored links. The sponsored links in the collection 621 is displayed one at a time. GUI controls 622, 624 are provided to permit a user to scroll backward or forward through the collection 621. The content section 610 comprises an inline frame and the advertisement section 620 comprises an inline frame. If multiple sponsored link collections are included in the advertisement section 620, an inline frame is provided for each such sponsored link collection.

In an exemplary embodiment, the sponsored links in the collection 621 are selected by sponsored link aggregators, such as Google or Yahoo!, based on their relevance to the content appearing in the content section 610, and delivered to the content publisher. The server computer of the content publisher then assembles the sponsored links into a collection and transmits them to a user computer for display one at a time. Alternatively, sponsored links are aggregated and managed by the search interface web server 130 and the sponsored links in the collection 621 are selected by the search interface web server 130.

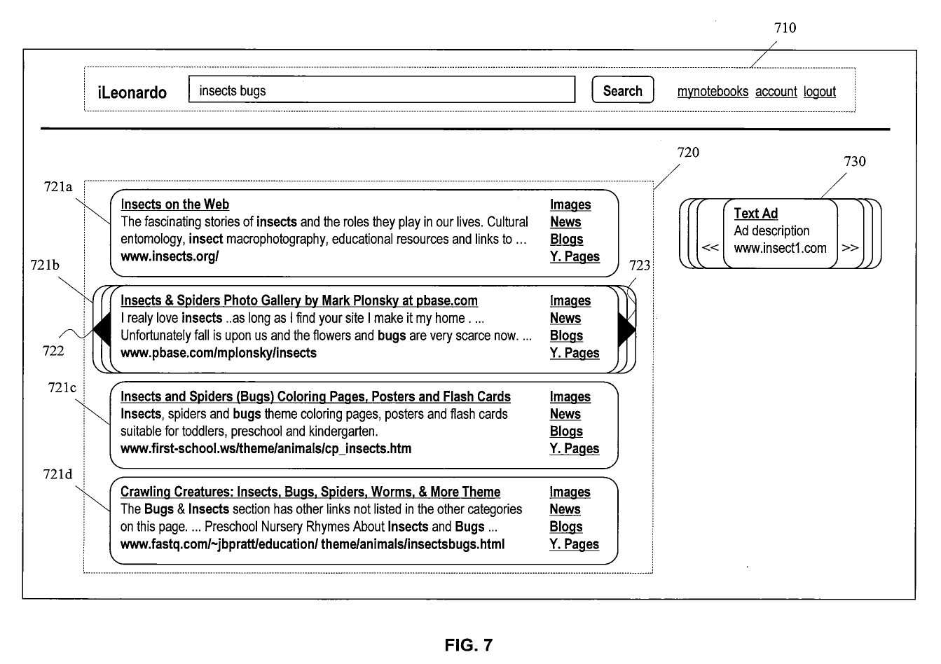

FIG. 7 is a schematic representation of a web page that includes a GUI according to still another embodiment of the present invention. This web page is generated by the search interface web server 130 and transmitted to a user for display when the user request an Internet search on the search query “insects bugs.” The GUI of the web page schematically represented in FIG. 7 has three different sections. The first section 710 is a section for inputting a search query, and includes a “mynotebooks” hyperlink that opens up a notebook section such as the first section 210 of FIGS. 2A-2C. The second section 720 is a section for displaying search results that are responsive to the search query. The third section 730 is a section for displaying sponsored links that are responsive to the search query.

Each of the three sections comprises at least one inline frame (also known as iframe). The first section 710 comprises one inline frame. The second section 720 comprises multiple inline frames. Each search result (721a, 721b, 721c, 721d) in the second section 720 is displayed in a separate inline frame. Some search results like the search result 721b have multiple pages. For these, the search result 721b is displayed one page at a time. Other pages of the search result 721b can be accessed by clicking on the left arrow 722 to turn pages back and on the right arrow 723 to turn pages forward. The third section 730 comprises one inline frame that displays a collection of sponsored links one at a time. Other sponsored links can be displayed in this section by clicking on “>>” to page forward and “<<” to page backward.

As described above, a GUI having inline frames permits any one of the inline frame to be updated with new content without disrupting the rest of the GUI. As a result, when the user clicks on the GUI controls 722, 723 appearing in the inline frame corresponding to search result 721b, the display contents of this inline frame are updated without disrupting the rest of the GUI, i.e., without causing the display contents of the rest of the GUI to also update. In the same manner, when the user clicks on the GUI controls “<<” and “>>” appearing in the inline frame for the third section 730, the display contents of this inline frame are updated without disrupting the rest of the GUI, i.e., without causing the display contents of the rest of the GUI to also update.

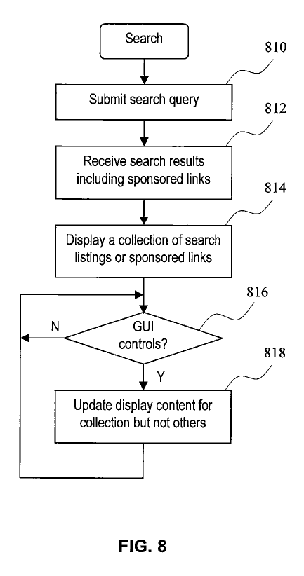

FIG. 8 is a flow diagram that illustrates the steps carried out by a client computer in response to a user who is making inputs to a GUI that displays a search listing collection or a sponsored link collection. The illustrated process begins with a user entering a search query and clicking on the “Search” button. In response, the client computer in step 810 submits the search query to the search interface server computer 130. Then, the search interface server computer 130 generates search results that are responsive to the submitted search query, including sponsored links, and returns them to the client computer. The search results that are responsive to the submitted search query, including sponsored links, are received by the client computer in step 812. A search result may be a collection of search listings or a collection of sponsored links. In such a case, the search listing or sponsored listing from the collection is displayed to the user one at a time with a graphic representing the collection and GUI controls for moving or scrolling forward and backward through the collection (step 814). The client computer monitors whether any of the GUI controls are selected in step 816. If it is, the display content for the collection is updated (step 818). For example, if the forward GUI control is selected, the next search listing or sponsored link in the collection is displayed without updating the display content for the other parts of the GUI. If the backward GUI control is selected, the previous search listing or sponsored link in the collection is displayed without updating the display content for the other parts of the GUI. To allow for immediate access to the new content in the collection to be displayed, it is preferable to have the content for all the search listings or sponsored links in a collection be generated and transmitted by the search interface server computer 130, received by the client computer, and stored locally in a system memory of the local computer.

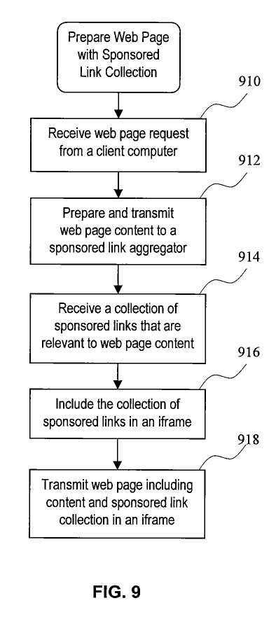

FIG. 9 is a flow diagram that illustrates the steps carried out by a web server computer to generate a web page including a sponsored link collection for display at a client computer. In step 910, the web server computer receives a request for a web page from a client computer. In response, the web server computer prepares content for the web page and transmits the content to a sponsored link aggregator (step 912). The sponsored link aggregator searches for sponsored links that are relevant to the content from the web server computer and transmits them to the web server computer. The web server computer receives the sponsored links from the sponsored link aggregator (step 914) and includes them in an iframe of the web page so that they will be displayable at a client computer as a collection of sponsored links that are displayed one at a time (step 916). The web page including the content and the sponsored links included in the iframe is transmitted to the client computer requesting the web page in step 918.

The functionalities of the GUIs described above may be implemented in the web pages using a markup language, scripting languages and associated libraries that provide inline framing, drag and drop, and other dynamic visual effects and user interface elements provided by the Prototype JavaScript Framework via the Document Object Model. The library that is employed in the embodiments described above is known as “scriptaculous.”

While particular embodiments according to the invention have been illustrated and described above, those skilled in the art understand that the invention can take a variety of forms and embodiments within the scope of the appended claims.

What is claimed is:

1. A graphical user interface (GUI) generated by a client computing device in communication with a server computing device over a communications network, the GUI comprising:
a first section including a text input field for a search query; and
a second section comprising at least a first subsection for displaying at least one search result that is responsive to the search query and a second subsection proximate said first subsection for displaying at least one advertisement that is relevant to said at least one search result and the search query,
wherein the displayed content of each one of the subsections can be updated independently with respect to the first section and other subsections.

2. The GUI according to claim 1, wherein the first subsection displays a group of search listings one at a time as a search result and displays GUI controls that enable navigation between the search listings of the group.

3. The GUI according to claim 2, wherein the second subsection is below the first subsection and is about as wide as the first subsection.

4. The GUI according to claim 1, wherein the second section further comprises a third subsection for displaying at least one search result that is responsive to the search query and a fourth subsection proximate said third subsection for displaying at least one advertisement that is relevant to said at least one search result and the search query, and wherein at least one of the third subsection and the fourth subsection is displayed in a background color that is different from that of the first and second subsection.

5. The GUI according to claim 1, wherein each of the subsections comprises an inline frame.

6. A method for generating a response to a search query, said method comprising the steps of:
receiving a search query;
storing search results that are responsive to the search query, wherein the search results include at least one search listing collection, and said at least one search listing collection includes at least two search listings that are displayed one at a time;
storing at least one advertisement that is responsive to the search query and relevant to said at least one search listing collection; and
transmitting the stored search results and said at least one advertisement as the response.

7. The method according to claim 6, wherein said at least one advertisement includes a first advertisement and a second advertisement, and wherein said first advertisement is associated with a first search listing of said search listing collection and said second advertisement is associated with a second search listing of said search listing collection.

8. The method according to claim 6, wherein said at least one advertisement includes a plurality of advertisements, each of which corresponds to one of the search listings of said search listing collection.

9. The method according to claim 8, wherein data that associates each search listing of said search listing collection to one of the advertisements are also transmitted, so that, when a particular search listing of the search listing collection is displayed, the advertisement that is most relevant to said particular search listing can be displayed therewith.

10. The method according to claim 6, wherein each of the stored search results and said at least one advertisement is transmitted as an inline frame.

11. A method for generating a response to a search query, said method comprising the steps of:
transmitting a search query to a server computer;
receiving search results that are responsive to the search query, wherein the search results include at least one search listing collection, and said at least one search listing collection includes at least two search listings that are displayed one at a time;
receiving at least one advertisement that is responsive to the search query and relevant to said at least one search listing collection; and
displaying the stored search results and said at least one advertisement.

12. The method according to claim 11, wherein the step of displaying includes the step of displaying a GUI including the stored search results and said at least one advertisement, wherein the GUI includes a first section having a text input field for a search query and a second section having at least a first subsection for displaying said at least one search listing collection and a second subsection proximate said first subsection for displaying said at least one advertisement.

13. The method according to claim 12, wherein the first subsection of the GUI displays GUI controls that enable navigation between the search listings of the search listing collection.

14. The method according to claim 13, wherein said at least one advertisement includes a plurality of advertisements, each of which corresponds to one of the search listings of said search listing collection.

15. The method according to claim 14, further comprising the steps of:
receiving an input through one of the GUI controls;
displaying a different search listing from the search listing collection in the first subsection; and
displaying a different advertisement in the second subsection.

16. The method according to claim 14, further comprising the steps of:
receiving an input through one of the GUI controls; and
displaying a different search listing from the search listing collection in the first subsection,
wherein the advertisement in the second subsection is not changed.

17. In a server computer connected to a client computer over a computer network, a method for generating a web page for display at the client computer, the web page having online advertisements that are relevant to contents appearing on the web page, said method comprising the steps of:
storing at least two online advertisements that have been determined to be relevant to contents appearing on a web page;
adding said at least two online advertisements to the web page such that said at least two online advertisements are displayed on the web page one at a time; and
transmitting the web page for display at a client computer.

18. The method according to claim 17, wherein the web page is configured with inline frames and said at least two online advertisements are added to one of said inline frames.

19. The method according to claim 18, further comprising the step of determining online advertisements that are relevant to contents appearing on the web page.

20. The method according to claim 18, further comprising the step of receiving from another server computer online advertisements that have been determined to be relevant to contents appearing on the web page.

21. A graphical user interface (GUI) generated by a client computing device in communication with a server computing device over a communications network, the GUI comprising:
a first section including content; and
a second section for displaying a collection of advertisements one at a time,
wherein the displayed content in the second section can be updated independently with respect to the first section.

22. The GUI according to claim 21, wherein the second section includes GUI controls that enable navigation between the advertisements in the collection.

23. The GUI according to claim 22, wherein the second section comprises an inline frame.
